(19) United States
(12) Patent Application Publication
(10) Pub. No.: US 2002/0143667 A1
(43) Pub. Date: Oct. 3, 2002

(54) Method and system for inventory management

(75) Inventor: Keith Ky Trieu Ho, Austin, TX (US)

Correspondence Address: Frank C. Nicholas, CARDINAL LAW GROUP, 1603 Orrington Avenue, Suite 2000, Evanston, IL, 60201, US

(73) Assignee: International Business Machines Corporation, Armonk, NY (US)

(21) Appl. No.: 09/821,066

(22) Filed: Mar. 29, 2001

(51) Int. Cl. G06F 17/60

(52) U.S. Cl. 705/28

(57) ABSTRACT

An inventory management system and method that is capable of generating lists of interchangeable parts. The system includes a database for indicating functional relationships between parts and a search engine for searching the database to identify groups of functionally interchangeable parts. The database includes a first table identifying the parts and a second table indicating the functional relationships between the parts. The search engine recursively searches the first and second tables to dynamically generate the lists of interchangeable parts. This permits a user to quickly determine what parts are available in inventory for manufacturing tasks, and promotes more efficient utilization of inventoried parts.

### TECHNICAL FIELD OF THE INVENTION

The present invention generally relates to parts inventory systems, and in particular, to an inventory management system capable of identifying interchangeable parts.

### BACKGROUND OF THE INVENTION

Some business enterprises use hundreds of thousands of parts in manufacturing various products. Many of these manufacturing enterprises have computer-based systems for monitoring parts held in inventory. These automated inventory systems generally allow users to select parts and determine their availability in the inventory.

One problem faced by manufacturers is excessive inventory, or more specifically, unbalanced inventory. Unbalanced inventories can occur in manufacturing operations where the demand for a certain part causes shortages of that part, while other parts remain in inventory, unused. These unused parts stored in inventory often become obsolete over time. Further, it is frequently the case that if these obsolete parts remain unused, they eventually become worthless, representing a loss to the business enterprise.

Thus, there is a need for an improved inventory system and method that permits a reduction in excessive or unbalanced inventory.

### SUMMARY OF THE INVENTION

In view of the foregoing, the present invention provides an inventory system and method for identifying interchangeable parts. An advantage of being able to identify interchangeable parts is that excessive and unbalanced inventories can be reduced.

According to one embodiment of the invention, a parts inventory system includes a relational database and a search engine. The database contains a table indicating functional relationships between the parts held in inventory. The search engine searches the database to identify groups of functionally interchangeable parts. The search engine can execute a recursive algorithm that repeatedly searches the database to dynamically produce a list of parts that can be used interchangeably. In this manner, the inventory system can provide users with a wider range of part selection, and can be useful for reducing excessive inventory.

### BRIEF DESCRIPTION OF THE DRAWINGS

FIG. 1 is a block diagram of an exemplary inventory system in accordance with the present invention;

FIG. 2 is a flowchart illustrating a method of operating the search engine of FIG. 1, in accordance with the present invention;

FIG. 3 is diagram illustrating an exemplary recursive search performed by the search engine of FIG. 1; and

FIG. 4 shows an exemplary list of interchangeable parts generated by the system of FIG. 1.

### DETAILED DESCRIPTION OF THE PRESENTLY PREFERRED EMBODIMENTS

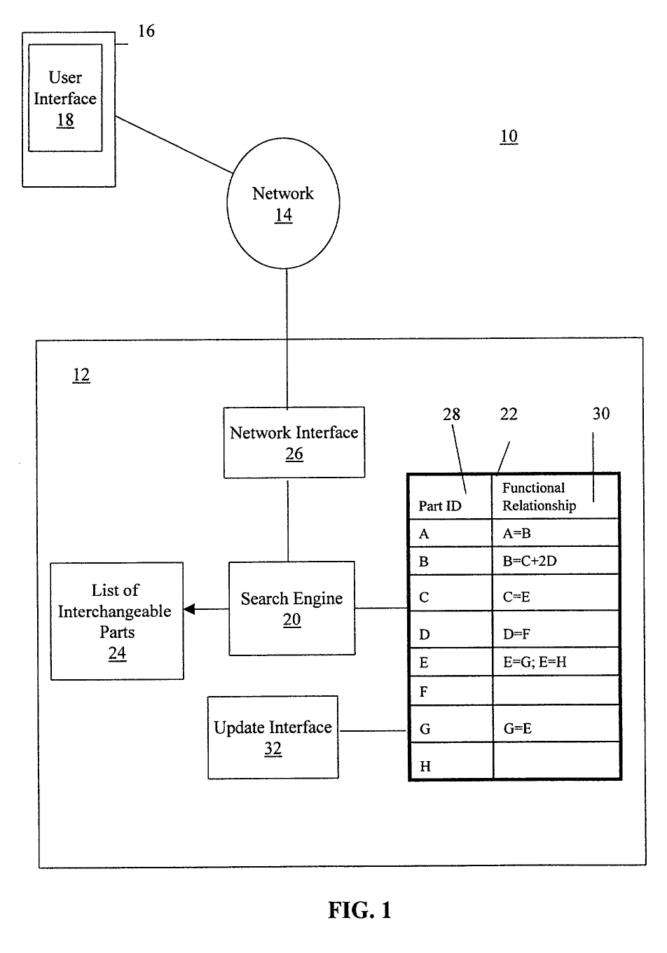

Turning now to the drawings, and in particular to FIG. 1, there is illustrated an exemplary inventory system 10 in accordance with the present invention. The system 10 includes a server-based host 12 communicating with a remote workstation 16 over a network 14, such as the Internet.

The remote workstation 16 can be a commercially-available personal computer or other similar device, having a conventional means, wireless or wired, for interfacing to a computer network, such as a modem or networking card. The remote workstation can also include a standard operation system program, such as Windows® available from Microsoft Corporation.

The user interface 18 can be a commercially-available web browser, such as the Internet Explorer available from Microsoft Corporation.

The server-based host 12 includes a network interface 26, a database 22, an update interface 32, and a search engine 20. The search engine 20 generates one or more lists of interchangeable parts 24.

The network interface 26 can include any suitable components for communicating with the remote workstation 16, such as conventional web-server software running on a commercially-available server platform having a network card.

The database 22 includes a part ID table 28 and a functional relationship table 30. The part ID table 28 contains part identifiers, such as part numbers, corresponding to each part in the inventory. The functional relationship table 30 identifies parts that are functionally equivalent, i.e., those having equal relationships. For example, if parts A and B are functionally equivalent, A=B, then part B can be used when part A is not available. In addition, if part B can be made of one part C and two parts D, i.e., B=C+D, then C and D can be used when neither A nor B are available. A predefined syntax relying on arithmetic symbols, such as “=”, “+”, “−”, etc. can be used to specify functional relationships.

The search engine 20 executes a recursive search algorithm that accesses the tables 28-30 of the relational database 22. The algorithm repeatedly searches the tables to produce the list of parts 24.

The update interface 32 permits system administrators to update the part information contained in the database 22. Though the interface 32, an administrator can add new part IDs and functional relationships to the tables 28,30, as well as update or delete existing part entries. The update interface 32 can be implemented as one or more HTML (hypertext markup language) web pages generated by a Java application executing on the server 12. Among other things, the web pages can include forms for entering part information, administrator information, such as user IDs and password, as well as selections for manipulating part records in the database 22.

The server-based host 12 can be built using a conventional three-tiered web server architecture having an HTTP (hypertext transfer protocol) server, application server, and database server (not shown). The functions of the network interface 26 can be performed by the HTTP server, the functions of the search engine 20 and update interface 32 can be performed by the application server, and the database 22 can be provided by the database server.

At least some of the functions and components of the server-based host 12 can be implemented in software using a standard programming language, such as Java, and stored in a computer-usable medium, such as a CD-ROM, solid-state memory, DVD, floppy disk, hard disk, or the like.

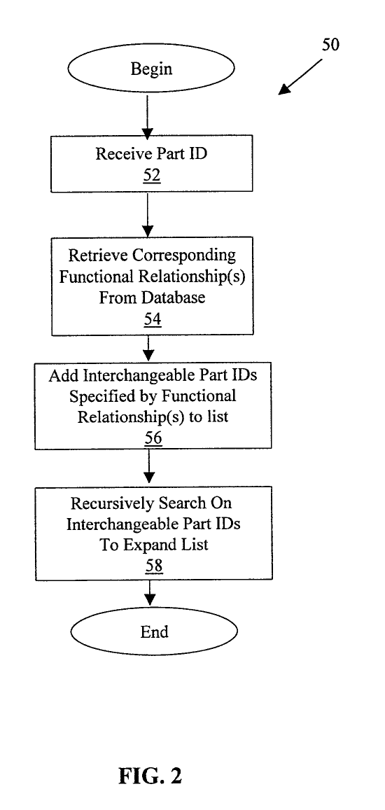

FIG. 2 is a flow chart 50 illustrating a method of operating the search engine of FIG. 1. In step 52, a part ID is received by the search engine 20. The part ID can be included in a user request web page sent from the remote workstation 16. In response to receiving the part ID, the search engine 20 retrieves one or more corresponding functional relationships from the database 30 (step 54). The interchangeable part IDs specified by the functional relationships are then added to the list of interchangeable parts 24 (step 56). The search engine 20 then proceeds to recursively search the database 22 on the interchangeable part IDs to expand the list 24 (step 58). In this manner, the grouping of interchangeable parts is done dynamically, and thus, it possible to deploy the inventory system in an online, real-time web-based application.

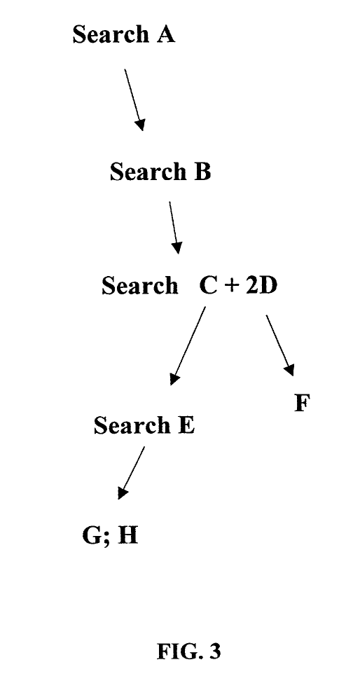

FIG. 3 is a diagram illustrating an exemplary recursive search performed by the search engine 20. This example relies on the part IDs and functional relationships illustrated in FIG. 1. In the first step of the recursive search, the search engine 20 receives part ID “A” as an initial input. The search engine 20 then searches the relational database 22 for the functional relationships corresponding to part ID “A”. The search results in retrieving the functional relationship A=B. Next, the search engine 20 searches the relational database 22 for the part ID “B”. This search returns the functional relationship B=C+2D. The search engine then searches the database 22 for part ID “C”. This returns the functional relationship C=E.

Next, the engine 20 searches the database 22 using part ID “D”. This returns the functional relationship D=F. And finally, the search engine 20 searches on the part ID “E”, which returns the functional relationship E=G and E=H.

After completing this recursive search routine, the search engine 20 generates the list of interchangeable parts. The list of parts is then transferred over the network 14 to the user interface 18, where it is displayed. The list can be part of an HTML web page, or any other file format suitable for display by the user interface 18.

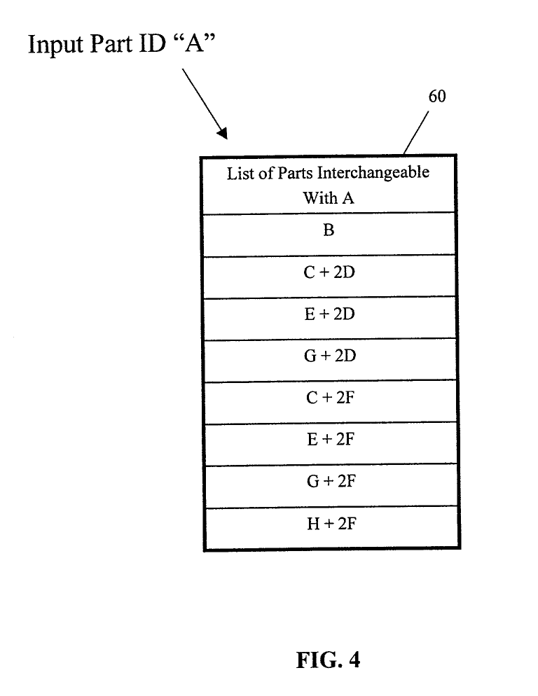

FIG. 4 shows an exemplary list 60 of interchangeable parts generated by the search depicted in FIG. 3, using the database 30 depicted in FIG. 1. The list 60 includes all combinations of interchangeable parts that are functionally equivalent to part A, which was initially input to the system. By using the recursive search routine, an expanded list of available parts is presented to a user. This can be an effective tool for reducing excessive inventory.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method of grouping parts in inventory, comprising:
defining a database for indicating functional relationships between a plurality of parts; and
searching the database to identify one or more groups of functionally interchangeable parts.

2. The method of claim 1, wherein the step of searching includes:
repeatedly searching the database to produce a list of parts that can be used interchangeably.

3. A method of generating a list of interchangeable parts, comprising:
defining a first table identifying a plurality of parts;
defining a second table, associated with the first table, indicating functional relationships between the parts; and
recursively searching the first and second tables to generate the list of interchangeable parts.

4. The method of claim 3, further comprising:
receiving a part identifier.

5. The method of claim 4, wherein the step of recursively searching includes:
applying the part identifier to the first table to retrieve a functional relationship from the second table, the functional relationship specifying an additional part identifier; and
applying the additional part identifier to the first table to retrieve an additional functional relationship from the second table.

6. A parts inventory system, comprising:
a database for indicating functional relationships between a plurality of parts; and
a search engine for searching the database to identify one or more groups of functionally interchangeable parts.

7. The parts inventory system of claim 6, wherein the database includes:
a first table identifying the parts; and
a second table, associated with the first table, indicating the functional relationships between the parts.

8. The parts inventory system of claim 7, wherein the search engine recursively searches the first and second tables to generate the list of interchangeable parts.

9. The parts inventory system of claim 7, wherein the search engine includes:
means for applying a part identifier to the first table to retrieve a functional relationship from the second table, the functional relationship specifying an additional part identifier; and
means for applying the additional part identifier to the first table to retrieve an additional functional relationship from the second table.

10. The parts inventory system of claim 6, further comprising:
an input interface for receiving a part identifier.

11. The parts inventory system of claim 6, further comprising:
a network interface permitting remote users to generate a list of interchangeable parts.

12. The parts inventory system of claim 6, further comprising:
a remote workstation for communicating with the search engine over a communication network.

13. A computer program product in a computer-usable medium, comprising:
means for defining a database for indicating functional relationships between a plurality of parts; and
means for searching the database to identify one or more groups of functionally interchangeable parts.

14. The computer program product of claim 13, wherein the searching means includes:
means for repeatedly searching the database to produce a list of parts that can be used interchangeably.

15. The computer program product of claim 13, comprising:
means for defining a first table identifying the parts;
means for defining a second table, associated with the first table, indicating the functional relationships between the parts; and
means for recursively searching the first and second tables to generate a list of the interchangeable parts.

16. The computer program product of claim 15, further comprising:
mean for applying a part identifier to the first table to retrieve a functional relationship from the second table, the functional relationship specifying an additional part identifier; and
means for applying the additional part identifier to the first table to retrieve an additional functional relationship from the second table.
